(19) United States
(12) Patent Application Publication
(10) Pub. No.: US 2014/0004286 A1
(43) Pub. Date: Jan. 2, 2014

(54) LIGHTER THAN AIR BALLOONS FROM LAMINATES COMPRISING BIO-BASED POLYESTER FILMS AND BIO-BASED POLYETHYLENE FILMS

(71) Applicants: Stefanos L. SAKELLARIDES, East Greenwich, RI (US); Keunsuk P. Chang, North Kingstown, RI (US)

(72) Inventors: Stefanos L. SAKELLARIDES, East Greenwich, RI (US); Keunsuk P. Chang, North Kingstown, RI (US)

(73) Assignee: Toray Plastics (America), Inc., N. Kingstown, RI (US)

(21) Appl. No.: 13/535,153

(22) Filed: Jun. 27, 2012

(51) Int. Cl. B32B 27/18; B05D 1/36; A63H 27/10; B05D 5/00; B32B 27/08; B32B 27/36

(52) U.S. Cl. 428/36.6; 428/35.7; 427/258

(57) ABSTRACT

A balloon made from a laminate film including at least one bio-based polyester layer of at least about 19.0 pMC of radiocarbon (¹⁴C) content is disclosed. The laminate film could further have additional layers such as a second bio-based polyester resin-containing layer of at least about 21.5 pMC of radiocarbon (¹⁴C) content, a linear low density polyethylene bio-based resin-containing layer of at least about 94 pMC of radiocarbon (¹⁴C) content, a metal layer, or combinations thereof.

### FIELD OF THE INVENTION

This invention relates to a lighter than air article such as a decorated balloon providing environmental benefits, such as increased raw material sustainability and reduced carbon footprint. More specifically, it relates to a laminated construction including at a least partially bio-based polyester film layer and also a polyethylene sealant film layer that may also be at least partially bio-based and methods of making the same.

### BACKGROUND OF THE INVENTION

Decorated balloons formed from film laminates including a polyester film layer (and commonly referred to as “Mylar balloons”) have been gaining increasing popularity vs. conventional latex balloons in view of their ability to be printed with vividly colorful images and more versatile and attractive appearance such as a Valentine's Day heart shape, flower shapes, animal shapes, and/or any famous characters printed thereon.

However, one drawback that limits commercial acceptance of such balloons is the increasing perception that they are environmentally unfriendly. This perception is stemming from several factors such as: the carbon footprint added by the production of helium used to inflate them (stemming from carbon dioxide emissions and depletion of fossil fuel); the perception that they only see short-time, single usage after which they are often discarded or drift away forming highly visible litter; and the fact that they are difficult or impossible to recycle (other than for trivial low volume re-uses such as cutting them up and using them as bird-repellent reflectors) or to undergo bio-degradation in landfill. This difficulty to recycle or undergo bio-degradation is inherent to their complex structure which is explained in more detail below.

Production and usage of materials based on biologically derived polymers are increasing due to concerns with raw material sustainability and greenhouse gas generation. Bio-based polymers are believed—once fully scaled-up—to reduce reliance on petroleum, reduced production of greenhouse gases, and are derived from renewable or sustainable sources such as plants. Analysis studies demonstrating significant reduction in greenhouse gas (“GHG”) emissions from the use of bio-based feedstock to produce polyesters such as PET have been presented in recent conferences: 56% lower GHG emissions for the production of 100% bio-based PET vs. petroleum-based (Draths Technology presentation at BioPlastek 2011); 45% lower emissions in PET production by just replacing the ethylene glycol part (one of the two monomers in PET) with bio-based ethylene glycol (presentation by the Coca-Cola Company at BioPlastek 2012); 30, 35, or 55% reduction in GHG emissions during production of bio-para-xylene (feedstock for terephthalic acid, a monomer for PET)—vs. the petroleum-based equivalent—depending on the bio-source (Virent presentation at BioPlastek 2012).

Bio-based polyethylene terephthalate or other polyesters differ from conventional petroleum-based polyesters in that ¹⁴C-isotope measurements show that the quantity of ¹⁴C in bio-sourced materials is significantly higher than in petroleum-based materials due to the continual uptake of this isotope by living plants and organisms. In petroleum-derived polyethylene terephthalate, however, ¹⁴C-isotope is essentially undetected using ASTM International standards (ASTM D6866). This is due to the half-life of ¹⁴C (about 5730±40 years) and the decay of this isotope over the hundreds of millions of years since the existence of the original organisms that took up said ¹⁴C, and turned into petroleum. Thus, bio-based or bio-sourced polyesters may be characterized by the amount of ¹⁴C they contain. The decay of ¹⁴C isotope is famously known for radiocarbon-dating of archeological, geological, and hydrogeological artifacts and samples and is based on its activity of about 14 disintegrations per minute (dpm) per gram carbon.

For example, US Publication No. 20090246430A1 states that “It is known in the art that carbon-14 (¹⁴C), which has a half-life of about 5,700 years, is found in bio-based materials but not in fossil fuels. Thus, ‘bio-based materials’ refer to organic materials in which the carbon comes from non-fossil biological sources. Examples of bio-based materials include, but are not limited to, sugars, starches, corns, natural fibers, sugarcanes, beets, citrus fruits, woody plants, cellulosics, lignocelluosics, hemicelluloses, potatoes, plant oils, other polysaccharides such as pectin, chitin, levan, and pullulan, and a combination thereof . . . . As explained previously, the detection of ¹⁴C is indicative of a bio-based material. ¹⁴C levels can be determined by measuring its decay process (disintegrations per minute per gram carbon or dpm/gC) through liquid scintillation counting. In one embodiment of the present invention, the bio-based PET polymer includes at least about 0.1 dpm/gC (disintegrations per minute per gram carbon) of ¹⁴C.” This is a useful definition of bio-based materials to distinguish them from their traditional petroleum-based counterparts. This reference teaches the use of bio-based ethylene glycols and terephthalic acids to form a bio-based polyethylene terephthalate resin useful for beverage bottles.

US Publication 20100028512A1 describes a method to produce bio-based polyester terephthalate (PET) resin which may then be used to make articles, containers, or packaging for food and beverage products. The application also discloses the use of bio-based polyethylene to produce closures, caps, or lids for bio-based PET containers as well as the use of bio-based polyethylene labels via film extrusion for said containers. However, there is no contemplation of producing bio-based polyethylene terephthalate films for balloons.

### SUMMARY OF THE INVENTION

The disclosure generally relates to balloons produced from at least partially bio-based film laminates. The film laminates may include bio-based thermoplastic films. For example, bio-based polyethylene terephthalate (PET) films, having acceptable balloon properties. Desirable balloon properties may include high barrier properties whereby the barrier properties are maintained through, for example, film structure, and treatment processes. Example process include plasma treatment processes used when metalizing the film. The resulting films may have a reduced carbon footprint relative to equivalent balloon structures made from conventional (petroleum-based) films of equivalent compositions.

Embodiments disclosed herein include a film including a high crystalline bio-based polyester core or base layer; an amorphous, optionally (but preferably) bio-based copolyester first skin layer; wherein the high crystalline bio-based polyester core layer and the first amorphous optionally bio-based polyester skin layer are co-extruded to form an oriented film; and a metallized layer.

In embodiments, the at least partially bio-based high crystalline polyester core layer includes high intrinsic viscosity (IV) homopolyesters or copolyesters of polyethylene terephthalate, polyethylene naphthalate, polybutylene terephthalate, polytrimethylene terephthalate, polyethylene terephthalate-co-isophthalate copolymer, polyethylene terephthalate-co-naphthalate copolymer, polycyclohexylene terephthalate, polyethylene-co-cyclohexylene terephthalate, etc. and other ethylene glycol or terephthalic acid-based polyester homopolymers and copolymers and blend combinations thereof (and alike polyester copolymers).

In embodiments, the at least partially bio-based high crystalline polyester core layer includes an intrinsic viscosity of about 0.50 to about 0.60. In embodiments, the at least partially bio-based crystalline polyester core layer includes an intrinsic viscosity of greater than about 0.60.

In embodiments, the optionally at least partially bio-based amorphous copolyester first skin layer includes isophthalate modified copolyesters, sebacic acid modified copolyesters, diethyleneglycol modified copolyesters, triethyleneglycol modified copolyesters, cyclohexanedimethanol modified copolyesters, and mixtures and combinations thereof.

Further embodiments include a lamination suitable for the construction of lighter than air materials including a thin, two layer thermoplastic film composed of an optionally at least partially bio-based amorphous copolyester first skin layer and an at least partially bio-based high crystalline polyester core layer; and an optional at least partially bio-based linear low density polyethylene and/or linear low density polyethylene sealant layer on said amorphous copolyester first skin layer.

The amount of bio-based content of the polyester can be characterized using test procedure ASTM D6866 which measures the amount of ¹⁴C isotope (also known as “radiocarbon”) in said polyester and compares it to a modern reference standard. This ratio of measured ¹⁴C to the standard can be reported as “percent modern carbon” (pMC). Petroleum or fossil fuel-based polyester will have essentially 0% radiocarbon (0 pMC) whereas contemporary 100% bio-based or bio-mass polyester should have about or near 100% radiocarbon (105.3 pMC). It is preferable that the ratio of biomass-based polyester in the high crystalline polyester film layer be at least equivalent to 1 pMC, and more preferably 19 pMC, and even more preferably about 105.3 pMC.

The amount of bio-based content of the polyethylene can be characterized using test procedure ASTM D6866 which measures the amount of ¹⁴C isotope (also known as “radiocarbon”) in said polyethylene and compares it to a modern reference standard. This ratio of measured ¹⁴C to the standard can be reported as “percent modern carbon” (pMC). Petroleum or fossil fuel-based polyester will have essentially 0% radiocarbon (0 pMC) whereas contemporary 100% bio-based or bio-mass polyethylene should have about or near 100% radiocarbon (105.3 pMC). It is preferable that the ratio of biomass-based carbon to petroleum-based carbon in the polyethylene film layer be at least 1 pMC, and more preferably 90 pMC, and even more preferably, about 105.3 pMC.

Embodiments of a process for fabricating a high barrier lamination suitable for the construction of lighter than air materials may include: a) providing a thin, two layer thermoplastic film composed of: an optional at least partially bio-based amorphous copolyester first skin layer, and an at least partially bio-based highly crystalline polyester core layer contiguously attached or coextruded upon one side of said amorphous copolyester first skin layer; b) plasma discharge-treating the side of the at least partially bio-based highly crystalline polyester core layer opposite the amorphous copolyester first skin layer to a surface energy of at least 36 dyne-cm/cm², more preferably 48-68 dyne-cm/cm²; c) depositing a metal barrier layer to an optical density of about 2.2 to about 3.2 upon the discharge-treated surface of said core layer; and d) coating or adhering contiguously an optional at least partially bio-based linear low density polyethylene (LLDPE) or low density polyethylene (LDPE)—or blends thereof—sealant layer on the side of the amorphous copolyester first skin layer opposite the side coextruded or contiguously attached to said core layer. Preferably, the at least partially bio-based LLDPE or LDPE or blend thereof sealant layer is extrusion-coated upon said at least partially bio-based polyester film.

In embodiments, the process includes depositing the metal barrier layer by vacuum deposition by methods well-known in the art for vapor-deposition of metals. In some embodiments, the metal barrier layer includes an aluminum barrier layer. In some embodiments, the aluminum barrier layer has an optical density of greater than about 2.6.

In some embodiments, the process further includes coating the at least partially bio-based polyethylene sealing layer including priming the amorphous copolyester first skin layer and extrusion-coating the sealant layer upon said primed skin layer.

In some embodiments the primer used to facilitate bonding of the skin layer to the sealing layer can be water-based for the purpose of enhancing raw material post-reclaiming: ability to wash away the primer by immersing recycled spent balloons in an aqueous wash bath after shredding would enable delamination of the polyester layer from the polyethylene layer and facilitate segregation into separate polyester and polyethylene recycle streams.

Additional advantages of this invention will become readily apparent to those skilled in this art from the following detailed description, wherein only the preferred embodiments of this invention is shown and described, simply by way of illustration of the best mode contemplated for carrying out this invention. As will be realized, this invention is capable of other and different embodiments, and its details are capable of modifications in various obvious respects, all without departing from this invention. Accordingly, the drawings and description are to be regarded as illustrative in nature and not as restrictive.

An embodiment of a balloon formed from a lamination may include a lamination including a bio-based polyester film with a radio carbon content of at least 19 pMC. The lamination may further include a sealant layer including polyethylene. The polyethylene may be a bio based linear low density polyethylene with a radio carbon content of at least 94 pMC.

In some embodiments, the bio-based polyester film may have a total thickness of 4 μm to 12 μm and include a biaxially oriented core layer including a bio-based oriented polyester and at least one skin layer including amorphous copolyester, and the lamination may include a sealant layer adjacent to a skin layer comprising amorphous copolyester.

The biaxially oriented core layer may comprise, consist, or consist essentially of polyethylene terephthalate with a radio carbon content of at least about 19 pMC. The biaxially oriented core layer may be co-extruded with the at least one skin layer including amorphous copolyester. The amorphous copolyester may have a melting point of less than 210° C.

The balloon of claim 4, wherein the at least one skin layer including amorphous copolyester includes isophthalate modified copolyester, sebacic acid modified copolyester, diethyleneglycol modified copolyester, triethyleneglycol modified copolyester, cyclohexanedimethanol modified copolyester, or polyethylene 2,5-furanedicarboxylate.

The amorphous copolyester may be bio-based. For example, the at least one skin layer may include, consist essentially of, or consist of polyethylene terephthalate-co-isophthalate, comprising at least about 20 pMC of radiocarbon content.

Another embodiment of a balloon formed from a lamination may include a lamination including a polyester film with a total thickness of 4 μm to 12 μm including a biaxially oriented core layer comprising a bio-based oriented polyester and at least one skin layer comprising amorphous copolyester, a sealant layer, and a gas barrier layer on an opposite side of the polyester film from the sealant layer. An oxygen transmission rate of the balloon may be less than 150 cc/m²/day, a dry bonding strength of the gas barrier layer to the surface of the polyester film may be more than 300 On, a sealing strength of the balloon may be more than 3.5 kg/in, and a floating time of the balloon when inflated may be more than 20 days.

The sealant layer may include polyethylene. The polyethylene may be a low density polyethylene. For example, a low density polyethylene with a radio carbon content of at least 94 pMC. The sealant layer may be adjacent to a skin layer including amorphous copolyester or the lamination may further include a water-based primer to anchor the sealant layer to the polyester film.

An embodiment of a method of making a balloon structure may include: forming a lamination including co-extruding a core layer including a bio-based oriented polyester and at least one skin layer comprising amorphous copolyester to form a polyester film and applying a sealant to the polyester film, and forming a balloon structure from the lamination.

The method may further include applying a gas barrier layer on an opposite side of the polyester film from the sealant layer. The method may further include printing a graphic design on a surface of the lamination and/or folding and packaging the balloon structure.

### BRIEF DESCRIPTION OF THE DRAWING

FIG. 1 is a cross-sectional view of a film in accordance with embodiments of the present disclosure.

### DETAILED DESCRIPTION OF THE INVENTION

Described are lighter than air articles such as a decorated balloon. The articles provide environmental benefits, such as increased raw material sustainability and reduced carbon footprint, by employing a laminated construction including an at least partially bio-based polyester film layer and also a polyethylene sealant film layer that can also be at least partially bio-based. Some embodiments of such a film-forming polyester is polyethylene terephthalate (abbreviated as “PET”) homopolymer or copolymer with one or both of its major monomer building blocks, terephthalic acid or ethylene glycol, derived from biological sources.

A consumer item, such as a balloon, that is at least partially bio-based, provides an excellent medium to advertise the retailer's and also the user's commitment to environmental issues; in addition, since such items are popular among young children, they are an excellent opportunity to educate them on environmental issues such as the importance of renewable resources.

Also described are methods for producing useful films and laminations using bio-based polyethylene terephthalate homopolymers and copolymers and also optionally bio-based polyethylene as a bonding layer for various lighter than air inflatable application, such as balloons, advertising decoys and the like. Such bio-based articles may contain a certain amount of ¹⁴C-isotope, a quantity that is thus distinguishable from petroleum-based polyesters. These bio-based polyesters are made from, in turn, bio-based monomers, which are derived from plant-based intermediates such as alcohols and sugars. The inventors have found solutions whereby the use of such materials in balloon applications can maintain current levels of quality, processability, and capital assets while reducing net carbon dioxide emissions and depletion of non-renewable resources.

A typical balloon constitutes an envelope containing a lighter than air gas such as helium. In addition to polyester, such as highly crystalline polyethylene terephthalate oriented film layer, film laminates used in balloon construction typically include metallization for improved gas barrier, which facilitates substantially permanent buoyancy. To ensure good metallization, the highly crystalline oriented polyester film is often coextruded together with an amorphous polyester skin, which improves adherence to the metal layer.

Since the envelope is made by bonding together two initially flat laminated panels, a good sealant material is preferably present in the laminate to facilitate good bonding of the panels, resist the forces of inflation, and increase durability over long periods. An extrusion-coated polyethylene layer, which is activated by heat sealing at a temperature above the melting point of polyethylene but below the melting point of PET, is a preferred method of providing good bonding.

It has been found that the environmental impact and specifically the carbon footprint of such balloon articles may be reduced by adopting biomass-based sources to replace one or multiple materials used in the aforementioned balloon lamination layers. The reduction in carbon footprint comes from the fact that such materials utilize lesser amounts of finite resources such as fossil fuels by replacing them with renewable plant-based resources; combined with the fact that plants renew themselves by uptaking their carbon from the atmosphere thus also contributing to overall reduction in ozone-depleting carbon dioxide (greenhouse gas). The described balloons include bio-based materials suitable for balloon assembly, namely bio-based polyester and bio-based polyethylene materials, which replace the equivalent petroleum-based polymers used in balloon construction.

Polyester films are commonly used for balloon construction. In particular, oriented polyethylene terephthalate film is a preferred embodiment of a suitable polyester material used in balloon construction. However, for a polymer to be fit-for-use in balloon applications, it is desirable that the bio-based polymer film match as many of the attributes possible—that, for example, multi-layer biaxially-oriented PET is well-known for—such as thermal and dimensional stability, heat sealability, printability, controlled coefficient of friction (COF), metallizability, gas transmission barrier, etc. In particular, for high barrier balloon structures, metallized oriented films should demonstrate good oxygen and moisture barrier properties. The described films can achieve desirable polyester film characteristics using bio-base polymers.

In embodiments, polyester films and laminates for lighter than air structures are disclosed having at least partially bio-based content. Further disclosed are final structures such as decorated balloons having long life-time (i.e. “float time”) characteristics and reduced carbon footprint.

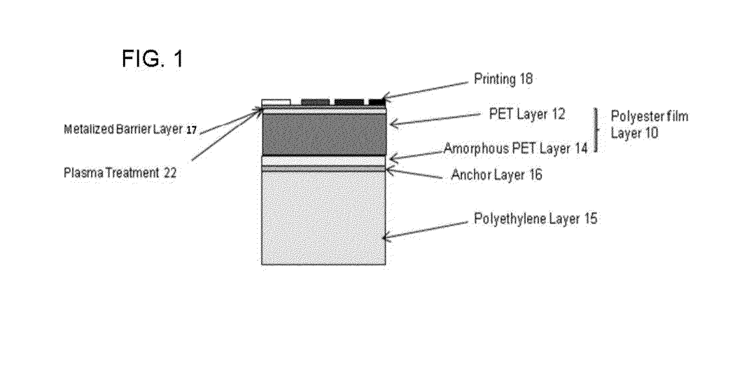

An embodiment shown in FIG. 1 includes a polyester film 10 including a core layer of highly crystalline, at least partially bio-based polyester layer 12 and an amorphous, optionally at least partially bio-based copolyester first skin layer 14. Preferably, the thickness of film 10 including layers 12 and 14 is 6-12 μm. The structure in FIG. 1 also includes a linear low density polyethylene (LLDPE) layer 15, which is optionally at least partially bio-based.

The high crystalline polyester core layer 12 can include any suitable material. For example, in embodiments, high crystalline polyester layer 12 includes high intrinsic viscosity (IV) homopolyesters such as at least partially bio-based PET or partially bio-based PEN or the at least partially bio-based copolyester of PET/PBT, for example, in embodiments, an intrinsic viscosity (IV)>0.50 or an IV of >0.60.

Crystallinity is defined as the weight fraction of material producing a crystalline exotherm when measured using a differential scanning calorimeter. For a high crystalline polyester, an exothermic peak in the melt range of 220° C. to 290° C. is most often observed. High crystallinity is therefore defined as the ratio of the heat capacity of material melting in the range of 220° C. to 290° C. versus the total potential heat capacity for the entire material present if it were all to melt. A crystallinity value of >35% weight fraction is considered high crystallinity.

The first amorphous copolyester layer 14 can include any suitable material. For example, in embodiments, amorphous copolyester layer 14 includes optionally isophthalate modified copolyesters, sebacic acid modified copolyesters, diethyleneglycol modified copolyesters, triethyleneglycol modified copolyesters, and cyclohexanedimethanol modified copolyesters. A preferable embodiment is for the amorphous copolyester to include least partially of bio-sourced monomer and/or comonomer.

The materials selected for the various layers can include any suitable material. For example, in embodiments, the polyester of the at least-partially bio-based high crystalline layer 12 can be polyethylene terephthalate, polyethylene naphthalate, polyethylene 2,5-furandicarboxylate, mixtures, copolymers and combinations thereof.

Further, in embodiments, the polyester of the optionally at least partially bio-based amorphous first skin layer are selected from polyethylene terephthalate, polybutylene terephthalate, polypropylene terephthalate, polyethylenenaphthalate, mixtures, copolymers and combinations thereof, polyethylene terephthalate-co-isophthalate, poly(ethylene-co-1,4cyclohexyldimethylene) terephthalate, and polyethylene 2,5-furandicarboxylate.

The bio-based crystalline polyester resin can be polymerized by polycondensation between two or more building blocks with diacid and diester functionality, at least one of which is plant-sourced. One process or method to produce such plant-sourced monomer, namely ethylene glycol, is to ferment sugar cane or other plant sugars and starches and distill into ethanol (CH3-CH2-OH). Through a dehydration process using mineral acids, strong organic acids, suitable catalysts and combinations thereof, the ethanol can be converted to ethylene monomer (CH2=CH2), which in turn can be oxidized into ethylene oxide

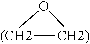

from which ethylene glycol (HO—CH2-CH2-OH) is derived by hydrolysis. One convenient low-cost source of sugar is the molasses generated as a by-product during the manufacture of sugar.

Diacids can also be derived from plant sources. For example there are several routes published for deriving terephthalic acid from biomass. Some of those routes are described in US Patent Application 2009/0246430 A1: one route involves extracting limonene from at least one bio-based material (for example citrus fruit peels), converting the limonene to at least one terpene, converting the terpene to p-cymene, and oxidizing the p-cymene to terephthalic acid:

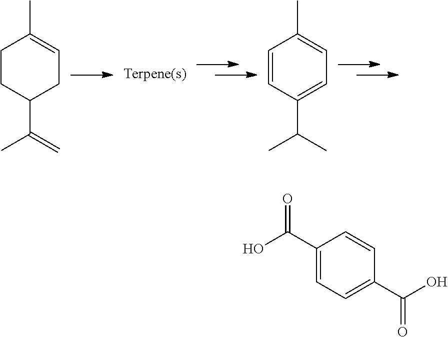

Another possible route to bio-terephththalic acid described in US Pat. Application 2009/0246430 A1 is through extraction of hydroxymethylfurfural from a bio-based material, such as corn syrup, sugars, or cellulose, converting hydroxymethylfurfural to a first intermediate, reacting the first intermediate with ethylene (which can also be derived from bio-sources such as described in paragraph 23) to form a second intermediate, treating the second intermediate with an acid in the presence of a catalyst to form hydroxymethyl benzaldehyde and oxidizing hydroxymethylbenzaldehyde to terephthalic acid.

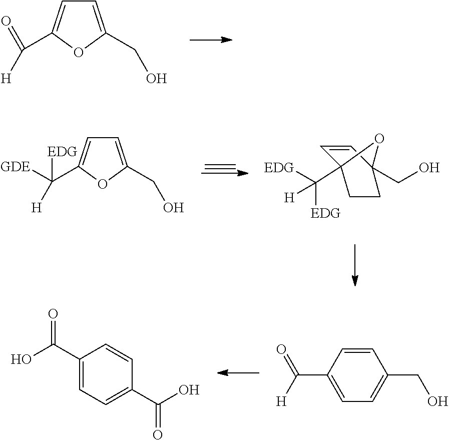

Another bio-derivative of plant-based hydroxymethylfurfural is 2,5-furandicarboxylic acid,

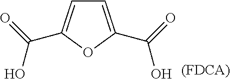 [SMILES: O=C(O)c1ccc(C(=O)O)o1]

derived by a catalytic oxidation. FDCA can be used as the bio-diacid source for preparing polyester films. For example, condensation of FDCA with ethylene glycol provides polyethylene 2,5-furanedicarboxylate (PEF); preparation and physical properties of PEF are described by A. Gandini et al. (Journal of Polymer Science Part A: Polymer Chemistry Vol. 47, 295-298 (2009): its melting and crystallization behavior follow the same pattern as those of PET (i.e. a crystallization rate slow enough for its melt to be able to be quenched into the amorphous state but high enough to enable achieving high crystallinity by heating from amorphous or cooling from the melt; these attributes are essential for a drop-in adaptation in a PET-type biaxially oriented film manufacturing process), with a glass transition temperature (following quenching) at 75-80° C. and a melting temperature of 210° C. (45° C. lower than that of PET). A conference presentation by the Avantium Company (“Avantium's YXY: Green Materials and Fuels”, 2^{nd} Annual Bio-Based Chemicals Summit, Feb. 15, 2011) reports that PEF has been processed into bottles and film with superior gas and moisture barrier properties vs. PET; however the presentation makes no mention of multilayer or laminated films or balloons containing PEF. Also there is no mention of taking advantage of the lower melting temperature of PEF for the purpose of utilizing it in the heat-sealable layer of a coextruded film. A bio-based PEF film material can have pMC ranging between about 79.0 and 105.3 depending on whether only the FDCA component or both the FDCA and EG are bio-sourced.

Another route towards bio-based terephthalic acid is through the intermediate preparation of trans, trans muconic acid

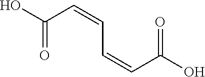

from biomass. A preparation method for cis, cis and cis, trans muconic acid from biomass (such as starches, sugars, plant material, etc.) through the biocatalytic conversion of glucose and others sugars contained therein, is described in U.S. Pat. No. 5,616,496. A subsequent isomerization of the above isomer mix into trans, trans muconic acid, necessary for conversion into terephthalic acid by reacting with dienophiles is described in US patent application 20100314243 by Draths Corporation.

Yet another route towards bio-based terephthalic acid is converting carbohydrates derived from corn or sugarcane and potentially from lignocellulosic biomass into bio-isobutanol via fermentation by employing appropriate yeasts. Such processes are described for example in US Patent Applications 20090226991 and 20110076733 by Gevo, Inc. The biologically-sourced isobutanol in turn is converted to para-xylene through a series of intermediate steps, according to procedures such as those described in US patent application 20110087000 by Gevo Inc. The bio-sourced para-xylene in turn is oxidized to bio-terephthalic acid through commercially known oxidation/purification processes.

In one embodiment, the first amorphous polyester skin layer 14 is petroleum-based. In another embodiment, the first amorphous polyester skin layer 14 includes bio-based polyester of at least about 20.3 pMC. For example, core layer 12 including a bio-based PET can have a contiguous skin layer 14 coextruded upon one side of layer 12 (this forms an embodiment of the multilayer PET film 10). If desired, a second skin layer can be coextruded upon the side of layer 12 (hereinafter referred to as coextruded layer 14′ although not depicted in the embodiment shown in FIG. 1) opposite the side in contact with first skin layer 14. It can be contemplated to interpose additional intermediate layers between the layers 14 and 12 and between 12 and 14′, in either symmetric or asymmetric structures. Preferably, all these additional layers—14, 14′, and intermediate layers—include bio-based polyester of at least about 20.3 pMC.

The films herein can have any suitable thickness as desired. Each layer can be selected at a suitable thickness as desired for the particular application. In embodiments, polyester film 10 has a total film thickness of from about 4.5 μm to about 12 μm, typically from about 5 μm to about 10 μm, particularly when used, for example, for balloon type applications.

In one embodiment, the high crystalline polyester film core layer 12 includes at least 19 pMC, preferably 105.3 pMC, containing bio-based polyester of about at least 29%, and preferably, 100% biomass content. The content or percentage of the film of bio-based origin is determined by comparing the amount of radiocarbon (¹⁴C isotope) to a modern reference sample. Radiocarbon (also known as “carbon 14”, “C-14”, or “¹⁴C”) is a weakly radioactive, naturally occurring element in all living organisms. ¹⁴C is taken up continuously by the organism (plant or animal) over its lifetime; when the organism dies (or is harvested such as sugar cane or corn or other crops), this ¹⁴C uptake ceases. Thus, contemporary biomass—or materials and articles made from such biomass—has a significant amount of radiocarbon, typically about 100% radiocarbon. In comparison, fossil fuels such as coal and petroleum oil have typically about 0% radiocarbon. This is because fossil fuels and petroleum were formed hundreds of millions of years in the past from buried plants and algae to form coal and petroleum deposits. The algae and plants from that time period ceased uptake of ¹⁴C and—as ¹⁴C has a half-life of about 5730 years, over those 300 million years or so since the original algae and plants died and turned into fossil fuels—the ¹⁴C isotope in them decayed to the point where such fossil fuels essentially contain zero radiocarbon. By comparing the amount of ¹⁴C in a bio-based polyester film to a “modern reference standard,” this ratio can be representative of a percent biomass content of the film with the units “pMC” (percent modern carbon).

The “modern reference standard” used in radiocarbon dating is a NIST (National Institute of Standards and Technology) standard with a known radiocarbon content equivalent to about the year 1950 AD. The year 1950 was chosen since it was the year that calibration curves for radiocarbon dating were established and also was a useful marker year prior to large-scale thermo-nuclear weapons testing which altered the global ratio of ¹⁴C to ¹²C. This standard represents 100 pMC. Present day (post-1950 AD) articles made from contemporary biomass sources typically show pMC greater than 100 due to the increase of ¹⁴C due to nuclear weapons testing (also known as “bomb carbon”). At the time of this writing, contemporary biomass-sourced articles have about 105.3 pMC. Thus, bio-based polyesters, e.g. polyethylene terephthalate using exclusively as diol component ethylene glycol recently derived from sugar cane or corn starches (which were subsequently fermented to ethanol or methanol and converted to ethylene, and then to ethylene oxide and ethylene glycol) and also using exclusively as diacid component terephthalic acid derived from biomass, would show a pMC of about 105.3. Fossil fuel/petroleum-based articles or polyesters would have a pMC of about 0. Thus, conventionally, it has been useful and convenient to assign a value of “100% biomass content” to articles that exhibit about or near 105.3 pMC and “0% biomass content” to articles that exhibit about or near 0 pMC. In this way, one can calculate and assign percent biomass content to articles that include both bio-based carbon and fossil fuel-based carbon. For example, a polyethylene terephthalate film made from a bio-based ethylene glycol source and a conventional (petroleum-based) terephthalic acid would have 20 wt % bio-sourced carbon atoms (since in the PET repeat unit there are 2 carbon atoms coming from ethylene glycol and 8 carbon atoms coming from terephthalic acid) and would exhibit a pMC of about 21.1. This would equate to about “30% biomass content” for said film (Reference material from Beta Analytic Inc. website www.betalabservices.com “Explanation of Results—Biobased Analysis using ASTM D6866”).

In one set of embodiments, the bio-based film core layer 12 is a crystalline polyethylene terephthalate and can be uniaxially or biaxially oriented. These resins have intrinsic viscosities between 0.60 and 0.85 dl/g, a melting point of about 255-260° C., a heat of fusion of about 30-46 J/g, and a density of about 1.4. The pMC value of these crystalline polyesters is preferably at least about 20.3, and more preferably about 105.3. The bio-based resin layer 12 is typically 2 μm to 350 μm in thickness after biaxial orientation, preferably between 3 μm and 50 μm, and more preferably between 12 μm and 23 μm in thickness.

The layer can further include other additives. Additional preferred additives in the layer include antiblock and slip additives. These are typically solid particles dispersed within the layer effectively to produce a low coefficient of friction on the exposed surface of the layer. This low coefficient of friction helps the film to move smoothly through the film formation, stretching and wind-up operations. Without such antiblocking and slip additives, the outer surfaces would be more tacky and would more likely cause the film being fabricated to stick to itself and to processing equipment causing excessive production waste and low productivity. Examples of antiblock and slip additives that may be used for polyester film applications include amorphous silica particles with mean particle size diameters in the range of 0.050-0.1 μm at concentrations of 0.1-0.4 weight percent of the layer; and/or calcium carbonate particles with a medium particle size of 0.3-1.2 μm at concentrations of 0.03-0.2 weight percent of the layer. Precipitated alumina particles of sub-micron sizes may also be used, either alone or blended with other antiblock types, with an average particle size, for example, of 0.1 μm and at a weight percent of 0.1-0.4 of the layer. Additional examples include, but are not limited to, inorganic particles, aluminum oxide, magnesium oxide, and titanium oxide; such complex oxides as kaolin, talc, and montmorillonite; such carbonates as calcium carbonate and barium carbonate; such sulfates as calcium sulfate and barium sulfate; such titanates as barium titanate and potassium titanate; and such phosphates as tribasic calcium phosphate, dibasic calcium phosphate, and monobasic calcium phosphate. Two or more of these may be used together to achieve a specific objective. As examples of organic particles, vinyl materials as polystyrene, crosslinked polystyrene, crosslinked styrene-acrylic polymers, crosslinked acrylic polymers, crosslinked styrene-methacrylic polymers, and crosslinked methacrylic polymers, as well as such other materials as benzoguanamine formaldehyde, silicone, and polytetrafluoroethylene may be used or contemplated.

One way to incorporate the aforementioned antbilock particles is via masterbatch addition. In that embodiment, high crystalline polyester core layer 12 is produced by extruding a pellet-to-pellet mix (or “dry blend”) of polyester A, which is at least partially bio-based (major component) and polyester B (minor component; masterbatch), which may or may not include partially bio-based carrier resin, and is loaded with the active antiblock and/or slip additives.

The polyester resin core layer 12 preferably includes 50 to 100 ppm of a conductive metal compound, such as calcium (Ca), manganese (Mg) and/or magnesium (Mn). The conductive metal compound can be added during the polymerization process as a catalyst or additive, or during the extrusion process in a masterbatch form to secure enough conductivity for electro-static pinning in the film-making process during casting of the extrudate. Less than 50 ppm of the metal compound may cause pinning issues; more than 100 ppm of the metal compound may degrade the hydrolysis and transparency performance of the film.

Examples of manganese compounds that may be used include manganese chloride, manganese bromide, manganese nitrate, manganese carbonate, manganese acetylacetonate, manganese acetate tetrahydrate, and manganese acetate dihydrate. Examples of magnesium compounds that may be used include magnesium chlorides and carboxylates. Magnesium acetate is a particularly preferred compound. An example of calcium compounds that may be used is calcium acetate. Magnesium acetate is a particularly preferred compound.

Additional additives, for example, phosphorous (P), can be used to suppress coloring (yellowness) of the polyester and can be added in an amount of between 30 to 100 ppm. Less than 30 ppm may not sufficiently reduce undesirable coloring of the film, but more than 100 ppm may make the film hazier.

The phosphorus-based compound employed is preferably a phosphoric acid-based compound, a phosphorous acid-based compound, a phosphonic acid-based compound, a phosphinic acid-based compound, a phosphine oxide-based compound, a phosphonous acid-based compound, a phosphinous acid-based compound, or a phosphine-based compound, from the standpoint of thermal stability, suppression of debris, and improving hue. Phosphoric acid-based and phosphonic acid-based compounds are particularly preferable.

These first and second skin layers 14 and 14′ can be coextruded on the respective sides of the core layer 12, each skin layer having a thickness after biaxial orientation between 0.1 and 10 μm, preferably between 0.2 and 5 μm, and more preferably between 0.5 and 2.0 μm. In a further embodiment in which the layer 14″s outer surface is used for receiving a vapor-deposited metal (and/or metal oxides or silicone oxides) or for receiving printing inks or coatings (for adhesives, gas barrier materials, solvent or aqueous) it is also contemplated to add an antiblock to aid in film handling. To facilitate adhesion of the metallized barrier layer 16, the surface of the bio-based core layer 12 (in the absence of a second skin layer 14′) or the surface of a second skin layer 14′ (if present) can be optionally surface-treated with either a corona-discharge method, flame treatment, atmospheric plasma, or corona discharge in a controlled atmosphere of nitrogen gas, carbon dioxide gas, or a mixture thereof (to the exclusion of oxygen gas); or to use chemical treatments such as isophthalic acid-based polyester or polyester dispersion coatings, in order to improve wetting tension further for the improved receptivity of said vapor-deposited metals, inks, adhesives, or coatings. The treatment method using corona discharge in a controlled atmosphere mixture of CO₂ and N₂ (to the exclusion of O₂) is particularly preferred, as depicted in the embodiment shown in FIG. 1 (“plasma treatment 22”). This method of discharge-treatment results in a treated surface that includes nitrogen-bearing functional groups, preferably 0.3% or more nitrogen in atomic %, and more preferably 0.5% or more nitrogen in atomic %. A wetting tension of at least 36 dyne-cm/cm² is preferred, and more preferably, a wetting tension of 39-48 dyne-cm/cm², and even more preferably, a wetting tension of 48-68 dyne-cm/cm². Additional deposition of an anchorage layer, such as Cu seeding or Ni seeding may be applied, before the main metal layer is deposited, in order to improve adhesion between the polyester film and the metal layer.

The optionally bio-based second skin layer 14′ can be a heat-sealable layer or non-heat sealable layer contiguously coextruded with the core layer opposite the first amorphous polyester skin layer 14. As a heat-sealable layer, layer 14′ may contain an anti-blocking agent and/or slip additives for good machinability and a low coefficient of friction.

The heat-sealable second skin layer 14′ will be optionally a bio-based PET copolymer or a bio-based PEF homopolymer, including at least about 20.3 pMC, and preferably about 90.1 pMC. A bio-based PET copolymer will preferably include a terephthalate-co-isophthalate copolymer with ethylene glycol, and further preferably, including of at least 20.3 pMC. In the embodiment in which layer 14′ includes a non-heat sealable, winding layer, this layer will include a crystalline PET with anti-blocking and/or slip additives. Optionally, said winding layer includes at least about 20.3 pMC bio-based polyesters.

As mentioned previously, the polyester film skin layers 14 and 14′ or—in the absence of skin layer 14′, layer 12—can include antiblock and slip additives for controlling COF and web handling. These are typically solid particles dispersed within the outer layer to produce a low coefficient of friction on the exposed surface of the outer layer(s). This low coefficient of friction helps the film to move smoothly through the film formation, stretching and wind-up operations. Without such antiblocking and slip additives, the outer surfaces would be more tacky and would more likely cause the film being fabricated to stick to itself and to processing equipment causing excessive production waste and low productivity.

Examples of antiblock and slip additives that may be used for polyester film applications include: amorphous silica particles with mean particle size diameters in the range of 0.050-0.1 μm at concentrations of 0.1-0.4 wt %; calcium carbonate particles with a medium particle size of 0.3-1.2 μm at concentrations of 0.03-0.2 wt %; precipitated alumina particles of sub-micron sizes may be used with an average particle size, for example, of 0.1 μm and a wt % of 0.1-0.4. Additional examples include inorganic particles, aluminum oxide, magnesium oxide, and titanium oxide; such complex oxides as kaolin, talc, and montmorillonite; such carbonates as calcium carbonate and barium carbonate; such sulfates as calcium sulfate and barium sulfate, such titanates as barium titanate and potassium titanate; and such phosphates as tribasic calcium phosphate, dibasic calcium phosphate, and monobasic calcium phosphate. Two or more of these may be used together to achieve a specific objective. As examples of organic particles, vinyl materials as polystyrene, crosslinked polystyrene, crosslinked styrene-acrylic polymers, crosslinked acrylic polymers, crosslinked styrene-methacrylic polymers, and crosslinked methacrylic polymers, as well as such other materials as benzoguanamine formaldehyde, silicone, and polytetrafluoroethylene.

For the embodiments in which the biaxially oriented multilayer bio-based polyester is PET-based (for example. in one embodiment depicted in FIG. 1, the combination of layers 12 and 14; additional skin layer(s) may be present as mentioned previously), the coextrusion process includes a two- or three-layered compositing die. In general, a preferred extrusion process for producing the polyester film, masterbatch and crystallizable polyester feed particles are dried (preferably less than 100 ppm moisture content) and fed to a melt processor, such as a mixing extruder. The molten material, including the additives, is extruded through a slot die at about 285° C. and quenched and electrostatically-pinned on a chill roll, whose temperature is about 20° C., in the form of a substantively amorphous prefilm. The film may then be reheated and stretched longitudinally and transversely; or transversely and longitudinally; or longitudinally, transversely, and again longitudinally and/or transversely. The preferred is sequential orientation of first longitudinally, then transversely. It can also be contemplated to orient the film simultaneously in both the longitudinal and transverse dimensions as some film-making processes allow. The stretching temperatures are generally above the glass transition temperature of the film polymer by about 10 to 60° C.; typical machine direction processing temperature is about 95° C. Preferably, the longitudinal stretching ratio is from 2 to 6 times the original longitudinal dimension, more preferably from 3 to 4.5. Preferably, the transverse stretching ratio is from 2 to 5 times the original transverse dimension, more preferably from 3 to 4.5 with typical transverse direction processing temperature about 110° C. Preferably, any second longitudinal or transverse stretching is carried out at a ratio of from 1.1 to 5 times. The first longitudinal stretching may also be carried out at the same time as the transverse stretching (simultaneous stretching). Heat setting of the film may follow at an oven temperature of about 180 to 260° C., preferably about 220 to 250° C., typically at 230° C., with a 5% relaxation to produce a thermally dimensionally stable film with minimal shrinkage. The film may then be cooled and wound up into roll form.

As described previously, one or both sides of film 10 can be coated or treated for adhesion promotion, surface conductivity, higher wetting tension etc. Preferred treatments include known methods such as corona treatment, plasma treatment, flame treatment, corona treatment in a controlled atmosphere of gases, and in-line coating methods.

A preferred embodiment in a balloon laminate construction is the inclusion of a polyolefin layer, which provides the low-melt temperature seal layer necessary for forming the balloon. Preferably the polyolefin includes polyethylene (PE), preferably low density polylethylene (LDPE), and even more preferably, linear low density polyethylene (LLDPE). Preferably, the LLDPE layer is at least partially bio-based. Bio-based polyethylene uses as its major ethylene monomer component derived from sugar cane or corn starches (which were subsequently fermented to ethanol or methanol and converted to ethylene). Whereas ethylene is the major monomer in LLDPE, additional co-monomers (higher alpha-olefins such as butene, hexene, octene) are used to control the density and other physical properties and are added at typical levels between 3 and 15 wt. %. If only the ethylene portion is bio-based, this comonomer inclusion would reduce the pMC from the maximum value of 105.3 to a value corresponding to the percentage of ethylene repeat units, which can be present at levels between 85-97 wt. %. Commercial examples of bio-based LLDPE are the “I'm green”™ line of bio-polyethylenes from BRASKEM SA, for example grades SLL118, SLL118/21, SLL218, SLL318, SLH118, SLH0820/30AF, SLH218), having published bio-carbon content around 89-90% (pMC level 93.7-94.8).

The anchor layer 16 may be selected from, but not limited to, a polyethylene dispersion, particularly polyethylenimine. Anchor layer 16 may be applied in dispersion in water or another solvent, using an application method such as gravure coating, Meyer rod coating, slot die, knife over roll, or any variation of roll coating. The applied dispersion may then be dried with hot air, leaving a layer approximately 0.01 to 0.1 μm thick. The first skin layer 14 may be treated prior to application of the anchor layer 16. The treatment is used to increase the surface energy of the skin layer 14 to increase wetting of the anchor layer coating and bond strength of the dried anchor layer 16. Treatment methods include but are not limited to: corona, gas modified corona, atmospheric plasma, and flame treatment.

An anchor layer that is water-based is preferable from the aspect of raw material post-recycling. It provides an opportunity to separate the metallized PET layer from the PE layer in segregated spent balloons by delamination of said layers through washing of, for example, shredded balloon waste. After delamination, the two different polymer layers can then be separated by gravity due to their respective differences in density. This separation adds more value to each recycling stream and makes recycling more economically advantageous.

A preferred embodiment is to incorporate a metallized layer 17 to improve gas barrier properties such as helium used to inflate the balloon by metallizing the discharge-treated surface of the bio-based polyester laminate film. The unmetallized laminate sheet is first wound in a roll. The roll is placed in a metallizing vacuum chamber and before deposition of the aluminum layer, a plasma treatment process is used to produce a treated surface 22; the plasma treatment process is preferably used to clean and functionalize the surface of the high crystallinity polyester core layer 12. The utilization of the plasma treatment produces very high metal adhesion and it is believed that it also increases the surface energy of the resultant metal surface. It is believed that both attributes are desired in combination in order to give commercial utility to the disclosed products/devices. In addition to plasma treatment processing, other surface treatment methods may be employed in the vacuum system. Included in the alternative methods are copper seeding, nickel seeding, or other sputtering treatment methodologies.

Subsequently, the metal layer 17 is vapor-deposited on the plasma discharge-treated bio-based polymer resin layer 12's surface by high speed vapor-deposition metallizing processes well known in the art.

The metal layer may include titanium, vanadium, chromium, manganese, iron, cobalt, nickel, copper, zinc, aluminum, gold, or palladium, the preferred being aluminum. Metal oxides can also be contemplated, the preferred being aluminum oxide. The metal layer shall have a thickness between 5 and 100 nm, preferably between 20 and 80 nm, more preferably between 30 and 60 nm; and an optical density between 1.5 and 5.0, preferably between 2.0 and 4.0, more preferably between 2.3 and 3.2 and most preferably 2.6-3.2. The metallized film is then tested for oxygen and moisture permeability, optical density, and metal adhesion. Preferred gas barrier values are in the range of 5-150 cc/m²/day oxygen transmission rate at 23° C. and 0% RH, and more preferably 31 cc/m²/day or less, and most preferably, 0.31-1.4 cc/m²/day. Preferred moisture barrier values are in the range of 0.03-0.70 g/m²/day water vapor transmission rate at 38° C. and 90% RH, and more preferably less than 0.31 g/m²/day.

In order to further improve the lifetime or float time of a balloon, a lamination that includes two or more gas barrier layers can be produced. For example, one of the gas barrier layers can be a metallized or ceramic layer and the other can be a polymer gas barrier layer. It is contemplated to overlay or over-coat the metallized/ceramic gas barrier layer 17 with the polymeric gas barrier layer 17′ (not shown in FIG. 1).

The combination of the metallized layer/ceramic deposition layer and the polymeric layer creates a very high gas barrier property that can further improve the life time of a balloon. In addition to improving the gas barrier characteristics of the laminate, a polymeric gas barrier layer 17′ can also prevent damage or removal of the typically inextensible inorganic gas barrier layer 17 during the severe processes of balloon fabrication and during handling by the end consumer. The polymeric barrier layer 17′ may be softer and more flexible than the metal/ceramic barrier layer 17 and is able to maintain a good barrier as the secondary barrier layer after possessing and handling.

The gas barrier layer 17′ can exist anywhere in the laminate, preferably, between the gas barrier layer 17 and the surface of the polyester film 12 or on the top of the gas barrier layer 17. The polymeric gas barrier layer can include ethylene-vinyl alcohol (EVOH), poly vinyl alcohol (PVOH), poly vinyl amine, and their mixture or co-polymer.

In addition, a proper cross-linker can be added to reinforce the polymeric gas barrier layer 17′. Examples of cross-linkers include melamine-based cross-linkers, epoxy-based cross-linkers, aziridine-based cross-linkers, epoxyamide compounds, titanate-based coupling agents, e.g., titanium chelate, oxazoline-based cross-linkers, isocyanate-based cross-linkers, methylolurea or alkylolurea-based cross-linkers, aldehyde-based cross-linkers and acrylamide-based.

The polymeric gas barrier layer 17′ may be applied as a dispersion or solution in water or another solvent, using an application method such as gravure coating, Meyer rod coating, slot die, knife over roll, or any variation of roll coating. The applied dispersion or solution may then be dried with hot air. The coating receiving layer's surface may be treated prior to application of the polymeric gas barrier layer to enhance wettability and adhesion of the polymeric gas barrier.

The polymeric barrier coating formulation may be selected to enable solutions to be in-line coated, stretched in the transverse orientation process without attendant cracking problems, and to provide excellent gas barrier properties. For example, a higher content of hydroxyl groups in the polymers (e.g. low ethylene content EVOH or PVOH) may provide increased water solubility and better oxygen gas barrier properties due to higher hydrogen bonding. Such polymers, however, may cause cracking in the layer upon transverse direction orientation, which may ultimately degrade the barrier property.

Once the laminations are prepared, the following process may be used to fabricate the balloons: 1) flexographic printing (layer 18 in FIG. 1) of graphic designs on the opposite surface of the sealant layer 15; 2) slitting of the subsequent printed web; 3) fabrication of balloons by die-cutting and heat sealing process; and 4) folding and packaging of the finished (un-inflated) balloons.

Flexographic printing may be used to print graphic designs on the balloons. The printing equipment used in this process may be set up in a manner that will prevent scratching, scuffing or abrading the gas barrier surface. The side of the laminate film opposite the sealant layer may be printed on the metallized (or unmetallized in some embodiments) surface with up to 10 colors of ink, using a flexographic printing press. Each color receives some drying prior to application of the subsequent color. After print application, the inks may be fully dried in a roller convective oven to remove all solvents from the ink prior to winding up and subsequent downstream operations.

Slitting may be accomplished in any suitable fashion. The slitting equipment used in this process is desirably set up in a manner that will prevent scratching, scuffing or abrading the gas barrier surface. In one embodiment, the printed web may be cut to lengths adequate for the balloon fabrication process by rewinding on a center driven rewinder/slitter using lay-on nip rolls to control air entrapment of the rewound roll.

Balloon fabrication may be accomplished in any suitable fashion. The fabrication equipment used in this process is desirably set up in a manner that will prevent scratching, scuffing or abrading the gas barrier surface. The slit webs may be fabricated into balloons by aligning two or more webs into position so that the printed graphics are properly registered to each other, then are adhered to each other and cut into shapes using known methods. A seam thickness of 1/64″ to ½″ (ca. 0.4-13 mm) may be used as the heat sealing area, as this seam thickness has been found to have greater resistance to defects with an optimal seam being 1/16″ to ⅛″ (ca. 1.6-3.2 mm). Optionally, a valve can be inserted into an opening and the layers abutting the valve adhered to form a complete structure.

Folding may be accomplished in any suitable fashion. The folding equipment used in this process is desirably set up in a manner that will prevent scratching, scuffing or abrading the gas barrier surface. The fabricated balloons may be mechanically folded along multiple axes using much different mechanical process or by hand. The balloon can be folded to the proper size mechanically and then mechanically or by hand, loaded into a pouch. The balloon can also be hand folded along multiple axes with care taken not to scratch, scuff or abrade the metalized surface. The hand-folded balloon can also be inserted into a pouch by hand or mechanically.

In addition, methods and any layer combinations deemed suitable for producing balloons based on laminations including at least high crystalline polyester film layers and linear low density polyethylene sealing film layers can be employed and the examples utilized herein do not in any way limit the scope of the invention, other than the provision for the substitution of fossil-based lamination components with bio-based lamination components of identical chemical composition should not adversely affect balloon properties. A representative example of such a balloon process is found in U.S. Pat. No. 7,799,399, which is incorporated by reference in its entirety. This patent describes in the abstract a process for fabricating a high barrier lamination suitable for the construction of lighter than air materials including providing a thin, two-layer thermoplastic film consisting of an amorphous copolyester skin and a high crystalline polyester core; plasma treating the high crystalline polyester core layer to a surface energy of at least 36 dyne-cm/cm² and most preferably to 48-68 dyne-cm/cm²; depositing a metal barrier layer to an optical density of about 2.2 to about 3.2; and extrusion coating a linear low density polyethylene sealant layer on the amorphous copolyester skin layer.

### EXAMPLES

The following Examples are being submitted to further define various species of the present disclosure. These Examples are intended to be illustrative only and are not intended to limit the scope of the present disclosure. Also, parts and percentages are by weight unless otherwise indicated.

### Crystalline Polyester Preparation

Polyethylene terephthalate resin A can be polymerized by any known method. For example, a molten mixture of 96.3 parts of bio-sourced ethylene glycol (obtained from India Glycols and having a plant-based carbon content, determined by Accelerator Mass Spectroscopy, ASTM-D6866-11, equal to 105.9 pMC signifying 100% bio-origin), 3.7 parts of fossil-based ethylene glycol (used to convey previously prepared catalyst slurry) and 51 parts of dimethyl terephthalate was heated, in the presence of calcium acetate transesterification catalyst, and methanol was removed via distillation which also served to reflux ethylene glycol vapors back to the reactor. After completion of the transesterification reaction, manifested by the termination of methanol evolution, the resulting bis-ethyleneterephthalate (“bisHET”) diester was heated, in the presence of an antimony trioxide esterification catalyst, and water and excess ethylene glycol were removed under vacuum leaving a residual melt of polyester resin. This melt was discharged via strand die into a cooling trough, pelletized, crystallized by passing through a fluidized bed under hot air at 155° C. and residence time 30 minutes, and then further dried to remove residual moisture to less than about 50 ppm. 161 ppm of calcium acetate (as Ca), 265 ppm of antimony trioxide (as antimony) and 59 ppm diethyl phosphate (as P), were also used to prepare polyester resin chip A. Chip intrinsic viscosity (IV) was 0.65 dl/g and surface resistivity 0.21 MΩ·m. The pMC level measured on resin A was 20.3, corresponding to a bio-based content of 31%. External particles were not added to polyester A at this step.

Particles, being SiO₂ particles of an average particle size of about 2.6 μm (micrometers), were admixed into polyethylene terephthalate B co-polymerized by a known method: A melt slurry of ethylene glycol and purified terephthalic acid was heated, in the presence of an esterification catalyst, and water and excess ethylene glycol were removed under vacuum leaving a residual melt of polyester resin. This melt was discharged via strand die into a cooling trough, pelletized, and then further dried to remove residual moisture to less than about 50 ppm. Tetraethyl ammonium hydroxide of 0.049 wt %, lithium acetate dihydrate of 0.882 wt %, antimony trioxide of 0.039 wt %, calcium acetate of 0.090 wt %, and trimethylphosphate of 0.042 wt %, were also used to prepare polyester resin B. The content of particles in the polyester pellet B was 2.0 wt %.

Next, 97 parts by weight of polyester resin pellets A and 3 parts by weight of polyester pellets B were mixed. The mixed pellets were extruded to produce melt stream I.

### Amorphous Polyester

An amorphous co-extruded surface layer for the polyester thermoplastic film was prepared as follows: An isophthalic acid co-terephthalic acid random co-polyester co-polymer with an IV of about 0.65 and a mol ratio of about 18% isophthalic acid and 82% terephthalic acid, commercially available from Invista as grade 8906™, was co-extruded on a base sheet including polyethylene terephthalate. Alternatively, a co-polyester consisting of a random co-polymer of cyclohexane dimethanol residues, commercially available from Eastman Chemical (as Eastar® 6763 PETG or glycol-modified PET) with an IV of about 0.70, can be utilized as the amorphous layer.

### Test Methods

The various properties in the above examples were measured by the following methods:

Intrinsic viscosity (IV) of the film and resin were tested according to ASTM D460. This test method is for the IV determination of poly(ethylene terephthalate) (PET) soluble at 0.50% concentration in a 60/40 phenol/1,1,2,2-tetrachloroethane solution by means of a glass capillary viscometer.

Melting point of polyester resin is measured using a TA Instruments Differential Scanning calorimeter model 2920. A 0.007 g resin sample is tested, using ASTM D3418-03. The preliminary thermal cycle is not used, consistent with Note 6 of the ASTM Standard. The sample is then heated up to 280° C. temperature at a rate of 10° C./minute, and then cooled back to room temperature while heat flow and temperature data are recorded. The melting point is reported as the temperature at the endothermic peak located in the temperature range between of 150 and 280° C.

The melt volume resistivity of the resin was measured by placing 14 grams of the material in a test tube, and then placing the tube in a block heater until the material completely melted (typically in 2-3 minutes). Next, parallel thin metal probes connected to a resistometer were dipped into the melt and the resistance was measured.

Radiocarbon/biomass content pMC was measured substantially in accordance with ASTM D6866-10 “Renewable Carbon Testing” procedure. Analytical methods used to measure ¹⁴C content of respective bio-based and petroleum-based polyolefin materials and articles made include Liquid Scintillation Counting (LSC), Accelerator Mass Spectrometry (AMS), and Isotope Ratio Mass Spectroscopy (IRMS) techniques. Bio-based content is calculated by deriving a ratio of the amount of radiocarbon in the article of interest to that of the modem reference standard. This ratio is reported as a percentage of contemporary radiocarbon (pMC or percent modem carbon) and correlates directly to the amount of biomass material present in the article.

Metal Optical Density is measured using a Gretag D200-II measurement device. The device is zeroed by taking a measurement without a sample in place. Then the optical density of the polyester film layers and metallic gas barrier layer is measured every 3″ across the web and the average is reported as the metal OD. Optical density is defined as the amount of light transmitted through the test specimen under specific conditions. Optical density is reported in terms of a logarithmic conversion. For example, a density of 0.00 indicates that 100% of the light falling on the sample is being transmitted. A density of 1.00 indicates that 10% of the light is being transmitted; 2.00 is equivalent to 1%, etc.

Wetting tension of the surfaces of interest was measured substantially in accordance with ASTM D2578-67. In general, the preferred value was an average value equal to or more than 40 dyne/cm with a minimum of 36 dyne-cm/cm²; and more preferably 48-68 dyne-cm/cm².

Oxygen barrier was measured on a MOCON Ox-Tran L series device utilizing ASTM D3985. Testing conditions used were 73° F. (23° C.), 0% relative humidity, and 1 atm. For this type of measurement, the gas barrier surface of the web is protected with a Stamark® lamination. The Stamark® film is a 1 mil (25 μm) thick cast polypropylene tape film coated on one with a pressure-sensitive adhesive. The pressure-sensitive adhesive side of the Stamark® film is applied to the gas barrier layer of the test specimen with care taken to eliminate wrinkles, bubbles, and creases. The Stamark® lamination protects the test specimen's gas barrier layer's surface (e.g. vapor-deposited aluminum) from handling damage, but makes no significant contribution to the oxygen barrier.

Metal dry bonding strength was measured by heat-sealing of a Dow PRIMACOR® 3300 film to the metallized surface of the test film on a Sentinel heat sealer in a room which is air-conditioned as 73±4° F. and 50±5% RH. Primacor® 3300 is an ethylene acrylic acid film which demonstrates good adhesion to metal surfaces. On the back side of the film, adhesive tape (3M 610) is applied to keep the film from breaking during the test. Heat seal conditions are 220° F. (ca. 104° C.) temperature, 20 seconds dwell time, and 40 psi (ca. 27.6 N/cm²) jaw pressure, 1 heated jaw. Prior to peeling, the sealed materials are cut so that each web can be gripped in a separate jaw of the tensile tester and a 1″×1″ (2.54 cm×2.54 cm) section of sealed material can be peeled. The peel is initiated by hand and then the two webs are peeled apart on an Instron tensile tester in a 180° configuration toward the PRIMACOR® film. If the metal is separated from the substrate and remains attached to the PRIMACOR® film, then the mean force of the peel is reported as the metal bond strength.

Wet bonding strength of the metal layer was measured by the same procedure as dry bonding strength, with the exception that a cotton swab soaked with water is used to apply water to the interface of the sealed area as it is being peeled.

Sealing strength of the balloon was measured as following. The seal layer is sealed to itself using a Pack Rite® heat sealer with 15″×⅜″ (381 mm×9.5 mm) jaw. The heat seal conditions are 405° F. (207° C.) temperature, 2 seconds dwell time, and 90 psi (ca. 62.05 N/cm²) jaw pressure, 1 heated jaw. Prior to peeling, the sealed materials are cut so that each web can be gripped in a separate jaw of the tensile tester and 1′×⅜″ (305 mm×9.5 mm) section of sealed material can be peeled. The two webs are peeled apart on an Instron tensile tester in a 90° configuration known as a T-peel. The peel is initiated at a speed of 2″/minute (ca. 51 mm/min) until 0.5 lbsf (2.22 N) of resistance is measured to preload the sample. Then the peel is continued at a speed of 6″/minute (ca. 152 mm/min) until the load drops by 20%, signaling failure. The maximum recorded load prior to failure is reported as the seal strength.

Floating time (or life time) of the balloon is determined by inflating it with helium gas and measuring the number of days that the balloon remains fully inflated. A balloon is filled from a helium source using a pressure regulated nozzle designed for “foil” balloons, such as the Corwin Precision Plus® balloon inflation regulator and nozzle. The pressure should be regulated to 16 inches of water column (0.4 N/cm²). The balloon should be filled with helium in ambient conditions of about 20° C. temperature and 1 atmosphere barometric pressure (10.13 N/cm²). The balloon should be secured using adhesive tape on the outside of the balloon below the balloon's valve access hole to avoid creating any slow leaks of helium gas through the valve. During the testing, the balloon should be kept in stable environment close to the ambient conditions stated. Changes in temperature and barometric pressure should be recorded to interpret float time results, as any major fluctuations can invalidate the test. The balloon is judged to be no longer fully inflated when the appearance of the balloon changes so that the wrinkles running through the heat seal seam area become deeper and longer, extending into the front face of the balloon; and the cross-section of seam becomes a v-shape, as opposed to the rounded shape that characterizes a fully inflated balloon. At this time the balloon will still physically float, but will no longer have an aesthetically pleasing appearance. The number of days between initial inflation and the loss of aesthetic appearance described above is reported as the floating time of the balloon.

### Example 1

A 36 gauge (9 μm) two-layer polyester film was prepared by co-extruding a first skin layer 14 (FIG. 1) from amorphous copolyester type 8906C from Invista adjacent to one side of a core layer 12 from the aforementioned bio-PET extruded melt stream I, at a skin/core weight ratio of 3.8%. The extrudate was cast on a cooling drum and subsequently stretched longitudinally at 250° F. (121° C.) by a ratio of 4.8 and then transversely at 240° F. (115.5° C.) by a ratio of 4.2 and heat-set at 460° F. (238° C.). The resulting thickness of the coextruded and oriented amorphous skin layer 14 was about 0.5 μm.

The film was then metallized with aluminum (17) on the core layer 12 side opposite the coextruded amorphous skin layer 14, to an optical density of 2.8. Prior to metallization, a plasma treatment process (22) was used in the metallizing chamber to prepare the surface for the metal deposition. The energy density of the treatment was approximately 1 kJ/m² and nitrogen gas was used.

The non-metallized surface of the metalized film (i.e. amorphous skin layer 14) was corona-treated and was coated with anchor coating 16 of a solution of polyethyleneimine-based resin (Mica A-131-X) using a gravure coater. The anchor layer 16 was dried in a convective dryer. The dried anchor surface was then extrusion-coated with petroleum-based LLDPE to form a sealant layer 15 (Dowlex® 3010, 13.6 μm thick), at a temperature of 600° F. (315.5° C.).

The extrusion-coated film was printed (18) on the barrier surface with up to 10 colors of ink, using a flexographic printing press. After print application, the inks were fully dried in a roller convective oven to remove solvents from the ink. The printed web was cut to lengths adequate for the balloon fabrication process by rewinding on a centre driven rewinder/slitter using lay-on nip rolls to control air entrapment of the rewound roll.

The slit webs were fabricated into balloons by aligning 2 or more webs into position so that the printed graphics were properly registered to each other, then adhered to each other by heat sealing (about 400 F and 1 second) and cut into circle shape (17″ or 43.2 cm diameter). The seam of the balloons was ⅛″ (3.2 mm). A valve, as described in U.S. Pat. No. 4,917,646 was inserted into an opening and the layers abutting the valve adhered to form a complete structure. The properties of the films, webs and balloons are summarized in Table 1.

### Example 2

Example 1 was repeated with the exception that in place of the fossil-fuel-based LLDPE used in example 1 (Dowlex® 3010, melt index 5.4), a bio-based LLDPE (grade SLL 318 from Braskem, melt index 2.7) was used. The properties of the films, webs, and balloons are summarized in Table 1.

### Comparative Example 1

Example 1 was repeated with the exception that in place of bio-based PET resin A (used in blending with PET resin B to provide melt stream I), a fossil-fuel-based PET resin with similar IV (0.65) and melt resistivity (0.18 MS m) was used.

TABLE 1

| | | | Comparative |
|---|---|---|---|
| | Example 1 | Example 2 | Example 1 |
| Floating time, days | 20-30 | 20-30 | 20-30 |
| Dry Metal Bonding | 400 | 400 | 400 |
| Strength, g/in | | | |
| Wet Metal Bonding | 3 | 3 | 3 |
| Strength, g/in | | | |
| OTR (cc/m²/day, | 31-109 | 31-109 | 31-109 |
| 23° C., 0% RH) | | | |
| Sealing Strength, | 4.5 | 4.5 | 4.5 |
| kg_{f}/in | | | |
| Combined % bio- | 14 | 59 | 0 |
| content | | | |

Comparative Example 1 was a balloon that met all the attributes required for a suitable balloon structure and float life. However, being made fully from petroleum-based or fossil-fuel-based materials, its pMC was 0, and contained no bio-based content.

Example 1 included a bio-based crystalline PET layer in the balloon structure. It also met all the requirements for a suitable balloon structure and float life, and had a significantly higher overall bio-based content of about 15% versus Comparative Example 1.

Example 2 included a bio-based crystalline PET layer and a bio-based LLDPE sealant layer as part of the balloon structure. It also met all the requirements for a suitable balloon structure and float life, and had a significantly higher overall bio-based content of about 59% versus Example 1 and Comparative Example 1.

This application discloses several numerical ranges in the text and figures. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

We claim:

1. A balloon formed from a lamination, the lamination comprising:
a bio-based polyester film with a radio carbon content of at least 19 pMC.

2. The balloon of claim 1, wherein the lamination further comprises a sealant layer comprising polyethylene.

3. The balloon of claim 2, wherein the polyethylene is a bio based linear low density polyethylene with a radio carbon content of at least 94 pMC.

4. The balloon of claim 1, wherein the bio-based polyester film has a total thickness of 4 μm to 12 μm and comprises a biaxially oriented core layer comprising a bio-based oriented polyester and at least one skin layer comprising amorphous copolyester, and the lamination further comprises a sealant layer adjacent to a skin layer comprising amorphous copolyester.

5. The balloon of claim 4, wherein the biaxially oriented core layer consists essentially of polyethylene terephthalate with a radio carbon content of at least about 19 pMC.

6. The balloon of claim 4, wherein the biaxially oriented core layer is co-extruded with the at least one skin layer comprising amorphous copolyester.

7. The balloon of claim 4, wherein the amorphous copolyester has a melting point of less than 210° C.

8. The balloon of claim 4, wherein the at least one skin layer comprising amorphous copolyester comprises isophthalate modified copolyester, sebacic acid modified copolyester, diethyleneglycol modified copolyester, triethyleneglycol modified copolyester, cyclohexanedimethanol modified copolyester, or polyethylene 2,5-furanedicarboxylate.

9. The balloon of claim 4, wherein the amorphous copolyester is bio-based.

10. The balloon of claim 4, wherein the at least one skin layer consists essentially of polyethylene terephthalate-co-isophthalate, comprising at least about 20 pMC of radiocarbon content.

11. A balloon formed from a lamination, the lamination comprising;
a polyester film with a total thickness of 4 μm to 12 μm comprising a biaxially oriented core layer comprising a bio-based oriented polyester and at least one skin layer comprising amorphous copolyester;
a sealant layer; and
a gas barrier layer on an opposite side of the polyester film from the sealant layer, wherein an oxygen transmission rate of the balloon is less than 150 cc/m²/day, a dry bonding strength of the gas barrier layer to the surface of the polyester film is more than 300 g/in, a sealing strength of the balloon is more than 3.5 kg/in, and a floating time of the balloon is more than 20 days.

12. The balloon of claim 11, wherein the biaxially oriented core layer consists essentially of polyethylene terephthalate with a radio carbon content of at least about 19 pMC

13. The balloon of claim 11, wherein the biaxially oriented core layer is co-extruded with the at least one skin layer comprising amorphous copolyester.

14. The balloon of claim 11, wherein the amorphous copolyester has a melting point of less than 210° C.

15. The balloon of claim 11, wherein the at least one skin layer comprising amorphous copolyester comprises isophthalate modified copolyester, sebacic acid modified copolyester, diethyleneglycol modified copolyester, triethyleneglycol modified copolyester, cyclohexanedimethanol modified copolyester, or polyethylene 2,5-furanedicarboxylate.

16. The balloon of claim 11, wherein the amorphous copolyester is bio-based.

17. The balloon of claim 11, wherein the at least one skin layer consists essentially of polyethylene terephthalate-co-isophthalate, comprising at least about 20 pMC of radiocarbon content.

18. The balloon of claim 11, wherein the sealant layer comprises polyethylene.

19. The balloon of claim 11, wherein the sealant layer comprises low density polyethylene.

20. The balloon of claim 11, wherein the sealant layer comprises low density polyethylene with a radio carbon content of at least 94 pMC.

21. The balloon of claim 11, wherein the sealant layer is adjacent to a skin layer comprising amorphous copolyester.

22. The balloon of claim 11, wherein the lamination further comprises a water-based primer to anchor the sealant layer to the polyester film.

23. A method of making a balloon structure comprising:
forming a lamination comprising co-extruding a core layer comprising a bio-based oriented polyester and at least one skin layer comprising amorphous copolyester to form a polyester film and applying a sealant to the polyester film; and
forming a balloon structure from the lamination.

24. The method of claim 23, further comprising applying a gas barrier layer on an opposite side of the polyester film from the sealant layer.

25. The method of claim 24, wherein an oxygen transmission rate of the balloon structure is less than 150 cc/m²/day, a dry bonding strength of the gas barrier layer to the surface of the polyester film is more than 300 g/in, a sealing strength of the balloon structure is more than 3.5 kg/in, and a floating time of the balloon structure is more than 20 days.

26. The method of claim 24, further comprising printing a graphic design on a surface of the lamination.

27. The method of claim 23, further comprising folding and packaging the balloon structure.

28. The method of claim 23, wherein the sealant layer comprises polyethylene.

29. The method of claim 23, wherein the sealant layer comprises low density polyethylene with a radio carbon content of at least 94 pMC.

30. The method of claim 23, further comprising applying a water-based primer to anchor the sealant layer to the polyester film.
